(19) United States
(12) Patent Application Publication
(10) Pub. No.: US 2018/0204232 A1
(43) Pub. Date: Jul. 19, 2018

(54) SYSTEM AND METHOD FOR BUYING AND SELLING ENERGY

(71) Applicant: International Business Machines Corporation, Armonk, NY (US)

(72) Inventors: Liam CHAMBERS, Bray (IE); Giovanni RUSSO, Dublin (IE); Robert SHORTEN, Dublin (IE)

(21) Appl. No.: 15/408,073

(22) Filed: Jan. 17, 2017

(51) Int. Cl. G06Q 30/02; H04L 29/08; G06Q 10/10

(52) U.S. Cl. CPC G06Q 30/0206; H04L 67/10; G06Q 50/06; G06Q 10/1093; H04L 67/18

(57) ABSTRACT

A system for buying and selling energy, includes a user interface which receives a user input to transmit an offer to buy or sell energy, a processor, and a memory, the memory storing instructions to cause the processor to function as an energy forecaster which generates an energy forecast for a vehicle, and a transaction manager which manages a transaction based on the energy forecast and the user input.

### BACKGROUND

The present invention relates generally to a system for buying and selling energy, and more particularly to a system for buying and selling energy which includes managing a transaction based on an energy forecast and a user input.

A conventional system for charging vehicles from another vehicle, uses a mobile charging station to transport an electric generator to the location of a vehicle in need of charging.

### SUMMARY

An exemplary aspect of the present invention is directed to a system for buying and selling energy, includes a user interface which receives a user input to transmit an offer to buy or sell energy, a processor, and a memory, the memory storing instructions to cause the processor to function as an energy forecaster which generates an energy forecast for a vehicle, and a transaction manager which manages a transaction based on the energy forecast and the user input.

Another exemplary aspect of the present invention is directed to a computer-implemented method of buying and selling energy. The method includes receiving a user input to transmit an offer to buy or sell energy, generating an energy forecast for a vehicle, and managing a transaction based on the energy forecast and the user input.

Another exemplary aspect of the present invention is directed to a computer program product for buying and selling energy, the computer program product comprising a computer readable storage medium having program instructions embodied therewith, the program instructions executable by a computer to cause the computer to receive a user input to transmit an offer to buy or sell energy, generate an energy forecast for a vehicle, and manage a transaction based on the energy forecast and the user input.

With its unique and novel features, the exemplary aspects of the present invention may allow an energy consumer vehicle and an energy provider vehicle to conveniently locate each other and negotiate, schedule and execute an energy sale/purchase transaction.

### BRIEF DESCRIPTION OF THE DRAWINGS

The exemplary aspects of the present invention will be better understood from the following detailed description of the exemplary embodiments of the invention with reference to the drawings, in which:

FIG. 1 illustrates a system 100 for buying and selling energy, according to an exemplary aspect of the present invention.

FIG. 2 illustrates a computer-implemented method 200 of buying and selling energy, according to an exemplary aspect of the present invention.

FIG. 3 illustrates a system 300 for buying and selling energy, according to another exemplary aspect of the present invention.

FIG. 4 illustrates a process flow of buying and selling energy from the perspective of the energy provider vehicle (e.g., energy seller vehicle), according to an exemplary aspect of the present invention.

FIG. 5 illustrates a process flow of buying and selling energy from the perspective of the energy consumer vehicle (e.g., energy buyer vehicle), according to an exemplary aspect of the present invention.

FIG. 6 depicts a cloud computing node according to another exemplary aspect of the present invention;

FIG. 7 depicts a cloud computing environment according to another exemplary aspect of the present invention; and

FIG. 8 depicts abstraction model layers according to another exemplary aspect of the present invention.

### DETAILED DESCRIPTION

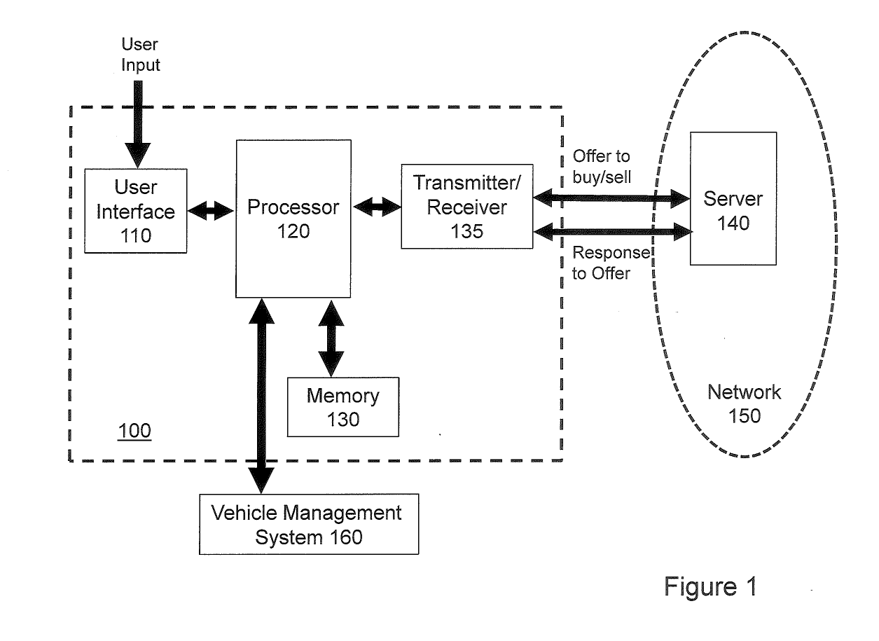

The invention will now be described with reference to FIGS. 1-8, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

FIG. 1 illustrates a system 100 for buying and selling energy, according to an exemplary aspect of the present invention. One or more computers of a computer system according to an embodiment of the present invention can include a memory having instructions which are executed by a processor to cause the processor to function as one or more elements of the system 100.

Thus, the system 100 may act in a more sophisticated and useful fashion, and in a cognitive manner while giving the impression of cognitive mental abilities and processes related to knowledge, attention, memory, judgment and evaluation, reasoning, and advanced computation. That is, a system is said to be “cognitive” if it possesses macro-scale properties perception, goal-oriented behavior, learning/memory and action—that characterize systems (i.e., humans) that are generally agreed as cognitive.

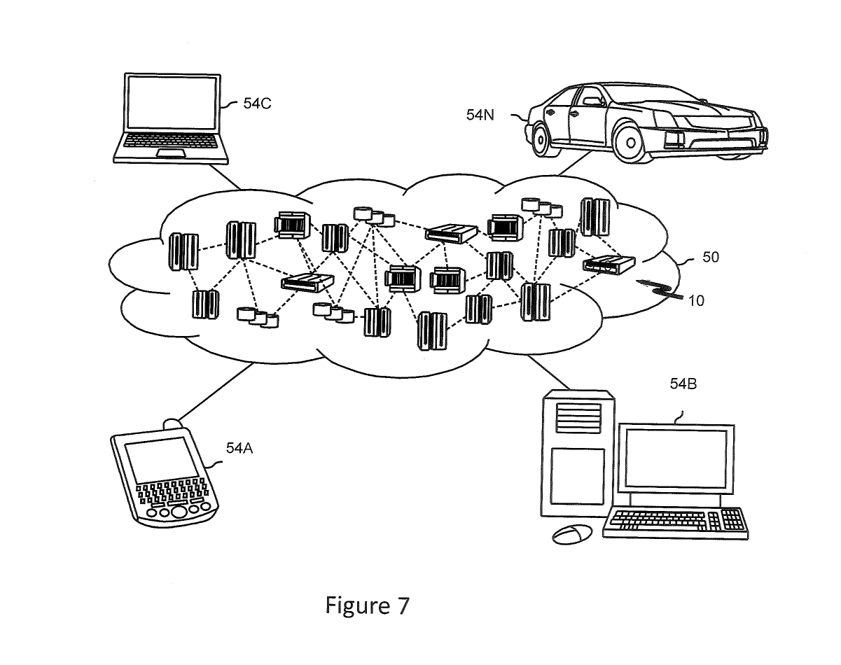

As will be described/illustrated herein, the exemplary aspects of the present invention (see e.g., FIGS. 1-5) may be implemented in a cloud environment 50 (see e.g., FIG. 7).

An exemplary aspect of the present invention may alleviate the concern of users of electric vehicles regarding the availability of charging stations or electric power for longer journeys, especially motorway or freeway driving. Trucks have the capacity to carry, charge and maintain large batteries that can be used to supply electric power to other vehicles in need of power, and at a minimal cost. An exemplary aspect of the present invention provides a software application that will enable drivers to request and purchase electricity from a truck fleet when stationary in a truck park, allowing the vehicle in need of energy and the vehicle with capacity to sell energy, to locate each other and negotiate, schedule and execute a commercial transaction for the energy.

An exemplary aspect of invention enables drivers of electrical vehicles to locate trucks with energy for sale. The inventors envision the car user (e.g., energy consumer) being able to locate or schedule a location with an energy supplier (e.g., energy provider) though a software application (e.g., an application on a mobile phone) where the car may connect to the supplier and recharge its battery using a normal connectivity capability.

The energy supplier (e.g., truck) may use the software application to broadcast the availability of a certain amount of energy, together with its price, location and duration at which the energy will be available. This will enable a transaction for the purchase and sale of energy to be completed. The battery of the supplier (e.g., truck) may be charged as part of normal travel operations and can be discharged to another electric vehicle though a normal cable.

The software application may also record and store the transaction activity in a network such as the cloud, providing an audit trail for reconciliation.

Referring again to FIG. 1, the system 100 includes a user interface 110 which receives a user input to transmit an offer to buy or sell energy, a processor 120, and a memory 130, the memory 130 storing instructions to cause the processor 120 to function as an energy forecaster which generates an energy forecast for a vehicle, and a transaction manager which manages a transaction based on the energy forecast and the user input.

The system 100 may be designed for use by both energy providers (e.g., users who are looking to sell energy) and energy consumers (e.g., users who are looking to buy energy). In an exemplary aspect, the system 100 is incorporated into the vehicle's operating systems. For example, the user interface 110 may be a display screen (e.g., touch screen) in the vehicle's dashboard, and the processor 120 may the vehicle's electronic control unit (ECU).

In another exemplary aspect, the system 100 is incorporated into a user's mobile device. For example, the system 110 may be embodied as a software application stored on a user's mobile phone, laptop computer, etc. In this case, the mobile device may communication (e.g., via wire or wirelessly) to the user's vehicle.

Further, the energy forecast may include, for example, a forecasted amount of energy available to charge an electric vehicle, such as where the user is an energy seller. Alternatively, the energy forecast may include a forecasted amount of energy necessary to operate an electric vehicle, such as where the user is an energy buyer.

The memory 130 may also serve as a data collection module for the system 100. The data collection module (e.g., memory 130) may collect, for example, user data, user trip data, energy price data, and so on. The energy forecaster (e.g., processor 120) may generate the energy forecast based on the user data, user trip data, and energy price data.

The user data may include, for example, user location data, the trip data comprises trip schedule data, and energy price data comprises energy market price data. The energy forecaster may forecast the amount of energy based on the data collected by the data collection module. Further, the user interface 110 may display the data collected by the data collection module.

The system 100 may also include a transmitter/receiver 135 which may serve as a network interface for interfacing with a network 150. The network 150 may include, for the Internet and more particularly, the “cloud” which operates on the Internet. The network 150 may include, for example, one or more servers which may be utilized by the system 100 for processing data and/or storing data.

As illustrated in FIG. 1, the transmitter/receiver 135 may transmit and receive an offer to buy/sell energy to and from a server 140 in network 150. The transmitter/receiver 135 may also transmit and receive a response to an offer to buy/sell energy to and from the server 140.

The server 140 may synchronize and record transactions, and for determine a location for charging an electric vehicle of an energy buyer by an energy seller. The energy seller (e.g., energy provider) may include, for example, a commercial truck, and the location for charging the electric vehicle comprises a location of a scheduled stop for the energy seller.

As illustrated in FIG. 1, in another exemplary aspect, the processor 120 of the system 100 may also interface with (e.g., communicate with by wire or wirelessly) a vehicle management system 160 of a vehicle. For example, the system 100 may be embodied by a software application in a user's mobile phone, and the user's mobile phone may be connected by wire or wirelessly (e.g., by Bluetooth® signal, etc.) to the vehicle management system 160 of the user's vehicle.

For example, in the case of a user of an energy provider vehicle, the energy forecaster may interface with the vehicle management system to acquire from the vehicle management system, data including an amount of energy available to be sold from the energy provider vehicle, a consumption rate of energy of the energy provider vehicle, a schedule of the energy provider vehicle including a time, location and duration of a next scheduled stop of the energy provider vehicle, and a current location of the energy provider vehicle.

In the case of a user of an energy consumer vehicle, the energy forecaster may interface with a vehicle management system which manages an energy consumer vehicle of the user, to acquire from the vehicle management system, data including an amount of energy needed to operate the energy consumer vehicle, a consumption rate of energy of the energy consumer vehicle, and a current location of the energy consumer vehicle.

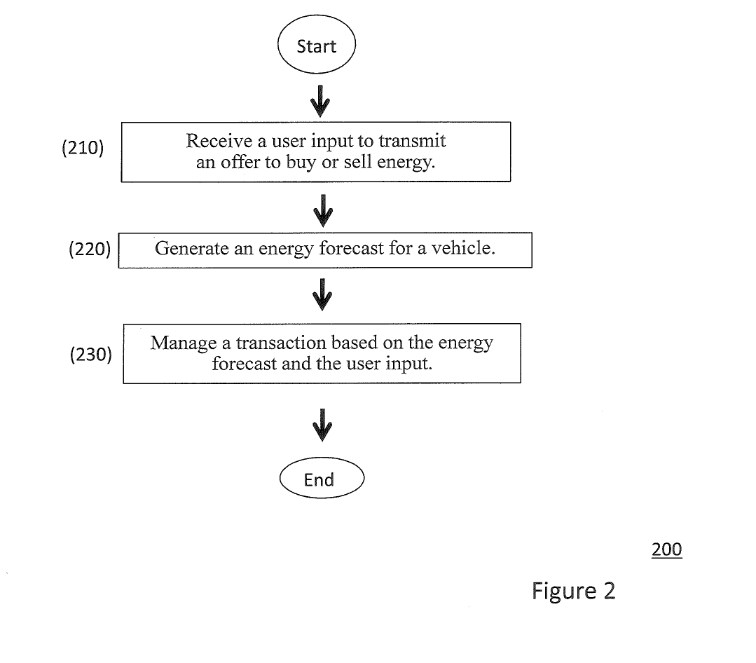

Referring again to the drawings, FIG. 2 illustrates a computer-implemented method 200 of buying and selling energy, according to an exemplary aspect of the present invention.

As illustrated in FIG. 2, the method 200 includes receiving (210) a user input to transmit an offer to buy or sell energy, generating (220) an energy forecast for a vehicle, and managing (230) a transaction based on the energy forecast and the user input.

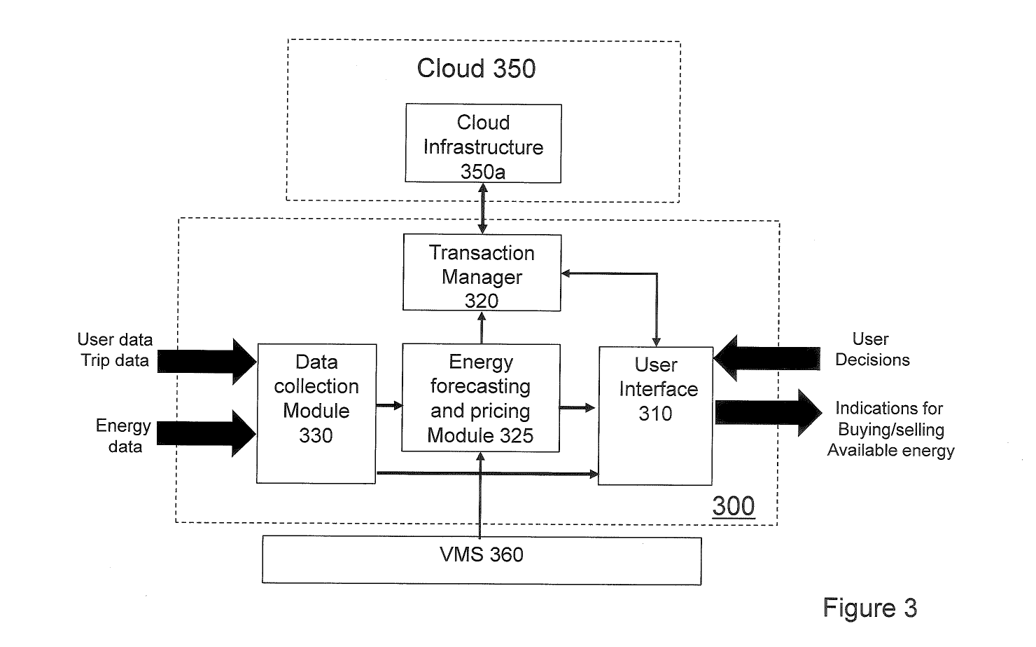

FIG. 3 illustrates a system 300 for buying and selling energy, according to another exemplary aspect of the present invention.

As illustrated in FIG. 3, the system 300 includes a user interface 310, a transaction manager 320, an energy forecasting and pricing module 325, and a data collection module 330.

The user interface 310 may include, for example, a touchscreen display, keypad, a natural language interface, etc. for inputting data into the system 300, and may also include a display screen, a microphone, speakers, etc. for providing data to the user. In particular, the user interface 310 may take as input, an output of the energy forecasting and pricing module 325 and the data collection module 330.

The user interface 310 may also provide to the user an indication for buying and/or selling energy. For example, the user interface 330 may provide (e.g., display) data from the data collection module 330. The user can also decide the price at which he would like to buy and/or sell energy and input his decision into the system 300 using the user interface 310.

The user interface 310 may include a graphical user interface that shows an indication to the user and collects his decision (e.g., to buy and/or sell energy). The user interface 310 may supply a decision of the user which is input to the user interface 310 to the transaction manager 320.

The transaction manager 320 may be implemented by a processor which executes instructions to manage a transaction for a sale or purchase of energy. The transaction manager 320 may be communicatively coupled (e.g., wirelessly coupled such as by a radio signal) to the Cloud 350 which includes Cloud infrastructure 350a (e.g., one or more servers connected to the Internet and storing or processing data). The transaction manager 320 may utilize the Cloud infrastructure 350a as a data processor, data repository, data cache, event recorder, etc. for the transactions which are managed by the transaction manager 320.

In particular, the Cloud 350 may offer the backend to synchronize and record transactions for the purchase and sale of energy. The Cloud infrastructure 350a can be also used to gather historical data, such as transaction history data (e.g., the parties to the transaction, date and location of the transaction, price at which the energy was sold, etc.), energy pricing history data and vehicle location history data.

The transaction manager 320 may take as input the user decisions and the output of the energy forecasting algorithm. The transaction manager 320 may ensure that a transaction with the Cloud 350 is a secure transaction. The transaction manager may return to the Cloud 350 and to the user interface, an output of the transaction.

The energy forecasting and pricing module 325 may be communicatively coupled (e.g., by wire or wireless) to a vehicle management system (VMS) 360 of a user's vehicle. The energy forecasting and pricing module 325 may acquire data such as energy availability, consumption rate, etc. which is generated by and/or stored in the VMS 360.

The energy forecasting and pricing module 325 may be implemented by a processor which executes instructions to perform an energy forecasting algorithm which takes as input, an output of the data collection module 330, together with energy availability and energy consumption data (provided by the energy provider vehicle), note that this information might be stored in the cloud infrastructure and accessed from there). The algorithm returns the amount of energy forecasted at the next stop;

The data collection module 330 may take as input, data regarding the user (e.g., current location), data regarding the user's trip (e.g., scheduled stops), data regarding energy pricing (e.g., energy pricing from a number of sources, including the competent authority, user preferences, market pricing, etc.). The data collection module 330 may organize this data and provide the data to the energy forecasting and pricing module 325 which utilizes the data in the energy forecasting algorithm. The data collection module 330 also provides this data to the user interface 310 which may generate a display of the data.

As noted above, in an exemplary aspect of the claimed invention, the system 100, 300 may be implemented in the form of a software application. The software application may be agnostic to operations systems.

Further, individuals may download the application and select from a number of roles including, for example, energy provider and energy consumer. The energy provider role may have additional roles including, for example, energy provider administrator and driver.

The energy provider administrator may enable a fleet of provider vehicles within the infrastructure, specifying fleet details and enabling drivers on the system 100, 300. This role may also be the role by which an independent operator would enroll a provider vehicle in the system 100, 300 (e.g., in the software application). The energy provider administrator may set the price for the energy or allow the system 100, 300 to transact at a price based on the available market rate.

The driver may enroll in a fleet of energy provider vehicles. The driver may have the role of enabling the broadcast of energy availability, location and duration of availability.

The consumer may register an energy consumer vehicle on the system 100, 300. The consumer may also provide a method of payment for energy consumed. For example, the consumer may enter a credit card number which is associated with the consumer's account.

The system 100, 300 may create a profile of maximum and minimum prices at which the consumer would bid for energy. The system 100, 300 may be supported by a secure cloud based infrastructure (e.g., cloud infrastructure 350a) which includes the functionally required for the system 100, 300 to function in the manner specified herein.

The system 100, 300 may also maintain an account for each energy provider vehicle and energy consumer vehicle which is enrolled in the system 100, 300. The account may be associated, for example, with the vehicle identification number (VIN) of the vehicles. The users of the system 100, 300 may access their accounts via the user interface 110, 310, in order to acquire data on their account, such as sale/purchase history, pricing data, etc.

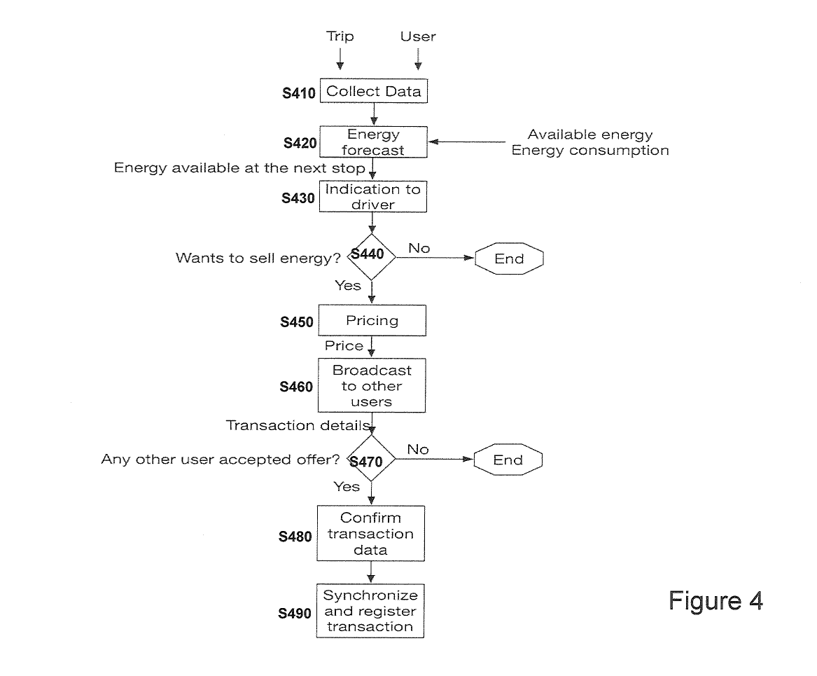

Referring again to the drawings, FIG. 4 illustrates an example process flow of buying and selling energy from the perspective of the energy provider vehicle (e.g., energy seller vehicle), according to an exemplary aspect of the present invention.

As illustrated in FIG. 4, a provider vehicle (e.g., a truck) carries one or more energy storage devices (e.g., batteries, additional batteries, etc.) that may be charged, for example, from the electricity generated through normal driving activity of the provider vehicle. These energy storage devices are connected to the on board vehicle management system of the provider vehicle.

The provider vehicle and/or the user of the provider vehicle may be provided with the system 300 for buying and selling energy (e.g., a software application).

In Step S410, the system 300 may acquire (e.g., from the vehicle management system), data such as (i) the energy available on board the provider vehicle at all times; (ii) the consumption rate of energy during the trip of the provider vehicle; (iii) when and where the provider vehicle is scheduled to stop; (iv) the current location of the provider vehicle.

Assume now that the user of the provider vehicle is driving to a stop schedule. In Step S420, based on the input that is available to the system 300 (e.g., information from the vehicle management system), the system 300 may forecast the amount of energy that will be available at the next scheduled stop and that can be shared with an energy consumer vehicle.

In Step S430, the system 300 may provide this forecast to the user (e.g., via the user interface 310.

In Step S440, the user (e.g., the driver of the provider vehicle) may decide whether to broadcast to energy consumer vehicles (e.g., other users of the system 300) that the user has energy available for sale and the price, location and time duration for which the energy will be available to an energy consumer vehicle.

If the user decides to broadcast that he has energy available, the user inputs to the system an instruction broadcast that he has energy available using the user interface 310.

Alternatively, the system 300 may be programmed to automatically determine for the user whether, when, and where to sell energy based on the energy forecast. The system 300 may also be programmed to automatically send out offers to sell energy based on the energy forecast.

In Step S450, the price of the energy to be sold by the energy provider vehicle may be determined by the user (e.g., the driver) or by a Fleet Manager (FM) as part of policy. Alternatively, the price of the energy to be sold may be set by the system 300 (e.g., by the transaction manager 320) based on the current market rate for energy (e.g., a bidding market via the system 300) on a marketplace where users of energy consumer vehicles may bid for the energy available.

In Step S460, the transaction manager 320 transmits (e.g., via the Cloud) that he has energy available. In particular, the transaction manager 320 transmits the details of his offer to sell energy to an energy consumer vehicle (e.g., price, location, duration, etc.).

In Step S470, the system determines whether the user's offer to sell energy has been accepted.

In Step S480, if the user's offer to sell energy has been accepted (e.g., on receiving a successful bid), the driver may confirm the location (e.g., truck Stop) of the energy exchange, allowing the energy consumer vehicle to navigate to the truck, couple and recharge its battery.

In Step S490, the transaction is recorded by the system 300 (e.g., in the Cloud 350, in the data collection module 330, etc.). All transactions may be synched to a secure cloud based storage and transaction layer and can be accesses by both the user of the provider vehicle and the user of the consumer vehicle via a personalised portal created once they download and register for the system 300 (e.g., a software application).

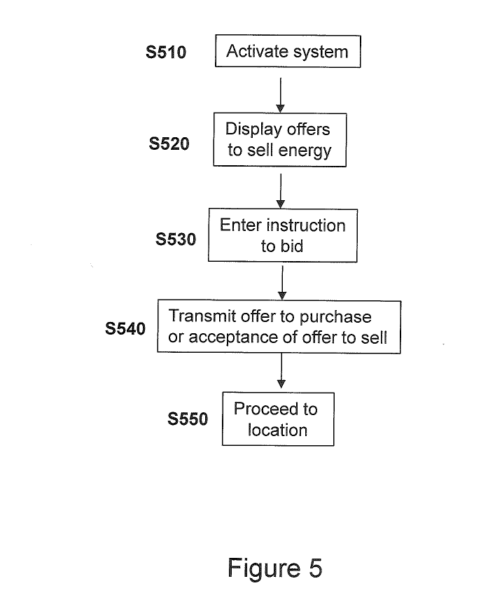

FIG. 5 illustrates an example process flow of buying and selling energy from the perspective of the energy consumer vehicle (e.g., energy buyer vehicle), according to an exemplary aspect of the present invention.

Like the driver of the energy provider vehicle, the driver of a consumer vehicle (e.g., electrical vehicle) may be provided with the system 300 for buying and selling energy (e.g., a software application).

In Step S510, the driver of the consumer vehicle may activate the system 300 (e.g., open the software application on his mobile phone).

In Step S520, the system 300 causes the user interface 310 to display (e.g., on a map, on a list, etc.) the offers to sell energy which has been broadcast by energy provider vehicles. In particular, the user interface 310 may display available truck energy relative to the current location of the consumer vehicle. The user interface 310 may also display an offer price for the available electricity and the duration for which it will be available from the provider vehicles.

The user interface 310 may also display for the driver of the consumer vehicle, an energy forecast that has been generated by the energy forecasting and pricing module 325. The driver can then determine whether, when and where to purchase energy based on the energy forecast.

Alternatively, the system 300 may be programmed to automatically determine for the user whether, when, and where to purchase energy based on the energy forecast. The system 300 may also be programmed to automatically send out offers to purchase energy based on the energy forecast.

In Step S530, if the driver requires energy or foresees a forthcoming requirement, then the driver may enter an instruction to bid for and purchase this energy using the user interface 310.

In Step S540, such instruction will cause the transaction manager 320 to transmit (e.g., via the Cloud) an acceptance of an offer to sell energy from an energy provider, or an offer to purchase energy including the details (e.g., location, price, etc.) of the offer. In particular, the transaction manager 320 transmits the details of his response to an offer to sell energy (or his offer to purchase energy) to an energy provider vehicle (e.g., price, location, duration, etc.).

In Step S550, the driver then proceeds to the location and recharges the vehicle.

The system 300 (e.g., software application) will also be capable of interaction with the VMS 360 to inform the driver of the energy consumer vehicle that energy may be required in a certain time frame, and suggest the nearest available location and price for this energy, assuming that it cannot recommend access to a normal charge station.

Referring to FIGS. 1-5, another aspect of the present invention is directed to a computer program product which may include, for example, a computer readable storage medium (hereinafter, the “storage medium”) that may store computer readable program instructions (hereinafter, the “computer program” or “instructions”) for performing the features and functions of the method 200 of buying and selling energy, and the system 100, 300 for buying and selling energy. That is, the storage medium may store the instructions thereon for causing a processing device (e.g., computer, instruction execution device, computing device, computer processor, central processing unit (CPU), microprocessor, etc.) to perform a feature or function of the present invention.

The storage medium can be a tangible device that can retain and store the instructions for execution by the processing device. The storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The storage medium, as used herein, should not be construed as merely being a “transitory signal” such as a radio wave or other freely propagating electromagnetic wave, an electromagnetic wave propagating through a waveguide or other transmission media (e.g., light pulses passing through a fiber-optic cable), or an electrical signal transmitted through a wire.

The processing device can access the instructions on the storage medium. Alternatively, the processing device can access (e.g., download) the instructions from an external computer or external storage device via a network such as the Internet, a local area network, a wide area network and/or a wireless network.

The network may include, for example, copper transmission cables, optical transmission fibers, wireless transmission, routers, firewalls, switches, gateway computers and/or edge servers. For example, the processing device may include a network adapter card or network interface which receives the instructions from the network and forwards the instructions to the storage medium within the processing device which stores the instructions.

The instructions for performing the features and functions of the present invention may include, for example, assembler instructions, instruction-set-architecture (ISA) instructions, machine instructions, machine dependent instructions, microcode, firmware instructions, state-setting data, or either source code or object code written in one or more programming languages (or combination of programming languages), including an object oriented programming language such as Java, Smalltalk, C++ or the like, and conventional procedural programming languages, such as the “C” programming language or similar programming languages.

The instructions may execute entirely on the processing device (e.g., a user's computer), partly on the processing device, as a stand-alone software package, partly on the processing device and partly on a remote computer or entirely on the remote computer or a server. For example, the instructions may execute on a remote computer which is connected to the processing device (e.g., user's computer) through a network such as a local area network (LAN) or a wide area network (WAN), or may execute on an external computer which is connected to the processing device through the Internet using an Internet Service Provider.

The processing device may include, for example, electronic circuitry including, for example, programmable logic circuitry, field-programmable gate arrays (FPGA), or programmable logic arrays (PLA) that may execute the instructions by utilizing state information of the instructions to personalize the electronic circuitry, in order to perform a feature or function of the present invention.

It should be noted that the features and functions of the present invention which are described above with reference to FIGS. 1-5 may be implemented by the processing device executing the instructions. That is, each block of the flowchart illustrations and/or block diagrams, and combinations of blocks in the flowchart illustrations and/or block diagrams, can be implemented by processing device executing the instructions.

The instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

That is, the instructions may be executed by a processing device to cause a series of operational steps to be performed by the processing device to produce a computer-implemented process, so that the executed instructions implement the features/functions/acts described above with respect to the flowchart and/or block diagram block or blocks of FIGS. 1-5

Thus, the flowchart and block diagrams in the FIGS. 1-5 illustrate not only a method, system, apparatus or device, but also illustrate the architecture, functionality, and operation of the processing device executing the instructions. In this regard, each block in the flowchart or block diagrams may represent a module, segment, or portion of the instructions, which comprises one or more executable instructions for implementing the specified logical function(s). In some alternative implementations, the features or functions in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

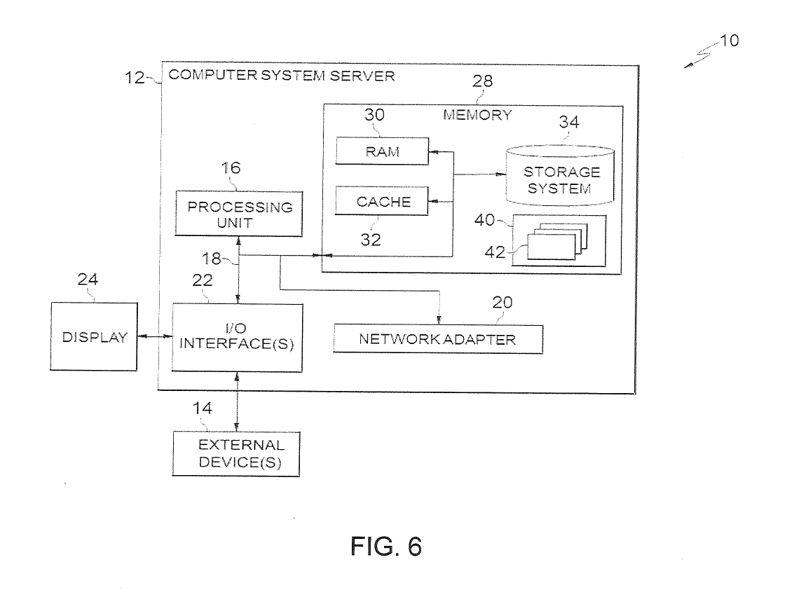

Referring again to the drawings, FIGS. 6-8 illustrate other exemplary aspects of the present invention.

It is to be understood that although this disclosure includes a detailed description on cloud computing, implementation of the teachings recited herein are not limited to a cloud computing environment. Instead, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where consumer is able to deploy and run arbitrary software, which can include operating systems applications. The consumer does not manage or control the underlying cloud infrastructure but has control over operating systems, storage, deployed applications, and possibly limited of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, a schematic of an example of a cloud computing node 10 is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 6, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof.

This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

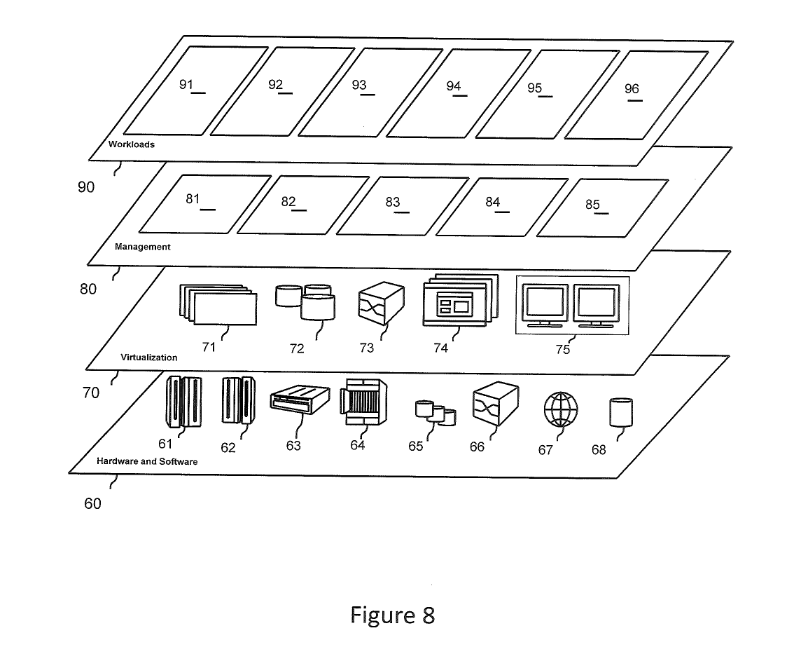

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and buying and selling energy 96.

With its unique and novel features, the exemplary aspects of the present invention may allow an energy consumer vehicle and an energy provider vehicle to conveniently locate each other and negotiate, schedule and execute an energy sale/purchase transaction.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive method and system is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A system for buying and selling energy, comprising:
a user interface which receives a user input to transmit an offer to buy or sell energy;
a processor; and
a memory, the memory storing instructions to cause the processor to function as:
an energy forecaster which generates an energy forecast for a vehicle; and
a transaction manager which manages a transaction based on the energy forecast and the user input.

2. The system of claim 1, wherein the energy forecast comprises one of:
a forecasted amount of energy available to charge an electric vehicle; and
a forecasted amount of energy necessary to operate an electric vehicle.

3. The system of claim 1, further comprising:
a data collection module that collects user data, user trip data, and energy price data,
wherein the energy forecaster generates the energy forecast based on the user data, user trip data, and energy price data.

4. The system of claim 3, wherein the user data comprises user location data, the trip data comprises trip schedule data, and energy price data comprises energy market price data.

5. The system of claim 3, wherein the energy forecaster forecasts the amount of energy based on the data collected by the data collection module.

6. The system of claim 3, wherein the user interface provides to a user, the data collected by the data collection module.

7. The system of claim 1, further comprising:
a network interface for interfacing with a network.

8. The system of claim of claim 7, wherein the network interface comprises:
a transmitter for transmitting:
an offer to buy or sell energy; and
an acceptance of an offer to buy or sell energy; and
a receiver for receiving:
an offer to buy or sell energy; and
an acceptance of an offer to buy or sell energy.

9. The system of claim 7, wherein the network comprises the cloud.

10. The system of claim 7, wherein network comprises a server for synchronizing and recording transactions, and for determining a location for charging an electric vehicle of an energy buyer by an energy seller.

11. The system of claim 10, wherein the energy seller comprises a commercial truck, and the location for charging the electric vehicle comprises a location of a scheduled stop for the energy seller.

12. The system of claim 3, wherein the user comprises a user of an energy provider vehicle, and the energy forecaster interfaces with a vehicle management system which manages the energy provider vehicle, to acquire from the vehicle management system, data including:
an amount of energy available to be sold from the energy provider vehicle;
a consumption rate of energy of the energy provider vehicle;
a schedule of the energy provider vehicle including a time, location and duration of a next scheduled stop of the energy provider vehicle; and
a current location of the energy provider vehicle.

13. The system of claim 3, wherein the user comprises a user of an energy consumer vehicle, and the energy forecaster interfaces with a vehicle management system which manages an energy consumer vehicle of the user, to acquire from the vehicle management system, data including:
an amount of energy needed to operate the energy consumer vehicle;
a consumption rate of energy of the energy consumer vehicle; and
a current location of the energy consumer vehicle.

14. A computer-implemented method of buying and selling energy, the method comprising:
receiving a user input to transmit an offer to buy or sell energy;
generating an energy forecast for a vehicle; and
managing a transaction based on the energy forecast and the user input.

15. The method of claim 14, wherein the energy forecast comprises one of:
a forecasted amount of energy available to charge an electric vehicle; and
a forecasted amount of energy necessary to operate an electric vehicle.

16. The method of claim 14, further comprising:
collecting data comprising user data, user trip data, and energy price data,
wherein the generating of the energy forecast comprises generating the energy forecast based on the user data, user trip data, and energy price data.

17. The method of claim 16, wherein the user data comprises user location data, the trip data comprises trip schedule data, and energy price data comprises energy market price data.

18. The method of claim 16, wherein the generating of the energy forecast comprises forecasting the amount of energy based on the collected data.

19. The method of claim 16, wherein the receiving of the user input comprises receiving the user input via a user interface which displays the collected data.

20. A computer program product for buying and selling energy, the computer program product comprising a computer readable storage medium having program instructions embodied therewith, the program instructions executable by a computer to cause the computer to:
receive a user input to transmit an offer to buy or sell energy; and
generate an energy forecast for a vehicle;
manage a transaction based on the energy forecast and the user input.
